(19) United States
(12) Patent Application Publication
(10) Pub. No.: US 2008/0100284 A1
(43) Pub. Date: May 1, 2008

(54) Magneto-sensitive angular-movement sensor

(75) Inventors: Daniel Dobler, Feldkirch (AT); Alexander Moosmann, Feldkirch (AT)

Correspondence Address: K.F. ROSS P.C., 5683 RIVERDALE AVENUE, SUITE 203 BOX 900, BRONX, NY, 10471-0900, US

(73) Assignee: Hirschmann Automotive GmbH

(21) Appl. No.: 11/796,139

(22) Filed: Apr. 26, 2007

(30) Foreign Application Priority Data
Apr. 27, 2006 (DE) 102006020254.6

(51) Int. Cl. G01B 7/30

(52) U.S. Cl. 324/207.2; 324/207.25

(57) ABSTRACT

A sensor system for measuring angular movements of measurement objects with at least one magnet (1) and a magneto-sensitive sensor (3), where according to the invention the magnet (1) is imbedded in a magnet support (2) and is circularly arcuate, and the magnet (1) has a cross section that varies angularly.

The invention relates to a sensor system that is configured to detect the angular movements of objects, comprising at least one magnet as well as a magneto-sensitive sensor, according to the characteristics of the preamble of claim 1.

Angular-movement sensor systems of this type that operate on magneto-sensitive basis, particularly by means of Hall-effect sensors, are basically known. Currently, the detection of particularly large angular movements (for example 270 degrees) can only be done with complex and cost-intensive angular-movement systems. Furthermore, a plurality of magneto-sensitive sensors are required to cover such large angular ranges.

It is therefore the object of the invention to provide a sensor system that is configured to detect the angular movements of measurement objects and that also allows large angular ranges to be detected without high complexity or expenses.

This object is achieved with the characteristics of claim 1.

According to the invention, the magnet is embedded in a magnet support and is of circular shape, the cross-section of the magnet in the circumferential direction varying continuously. This way, it is possible to capture an accordingly large angular range with only one revolution (covering 360°) or also with a plurality of successive revolutions. At the same time, the design of the sensor system remains simple and cost-efficient since the magnet (either a permanent magnet made of metal or plastic or an appropriate alloy or a solenoid) is embedded and protected in the magnet support. This way it is easily possible to attach the magnet support to the measurement object, it also being alternatively conceivable that the measurement object itself forms the magnet support. Advantageously, the magnet support is made of injection-molded plastic and is attached as a separate unit to the measurement object or is produced together with the measurement object.

Furthermore, it is essential to the invention that the cross-section of the magnet in the circumferential direction varies continuously. Depending on the evaluation of the signal, the continuously varying cross-section in the circumferential direction is selected such that it changes in the circumferential direction, meaning in its radial dimension, in a steadily linear fashion or alternatively in an irregular linear fashion. As a result, the output signal of the magneto-sensitive sensor, for example the Hall-effect sensor, increases or decreases as a function of the direction of rotation until a sudden change occurs, at which the course of the output signal reverses.

The arrangement according to the invention allows the measurement of angular ranges of up to 360° using a simple design of the arrangement.

A preferred embodiment exists in vehicle technology, particularly for passenger cars or heavy goods vehicles as well as for commercial vehicles (automotive angle measurement). By way of example, the measurement of the angle of a trunk lid of a passenger is mentioned. The arrangement according to the invention enables a determination of the position of the trunk lid, using the simplified design. This is important particularly in this case so that not only the end positions (closed or open) are captured, but also a preliminary detent position. This event exists when the user of the vehicle has almost entirely closed the trunk lid (the rotary latch of the trunk lid is located in a preliminary detent position) and a power-operated arrangement moves the trunk lid into its closed and thus final locked position (referred to as power closure). The same also applies to a power-operated door or trunk lid that cannot only be brought into the closed position, but also into the open position by means of the motor force.

Two illustrated embodiments of a sensor system according to the invention, to which however the invention is not limited, are explained hereinafter and described with reference to the figures.

Shown in:

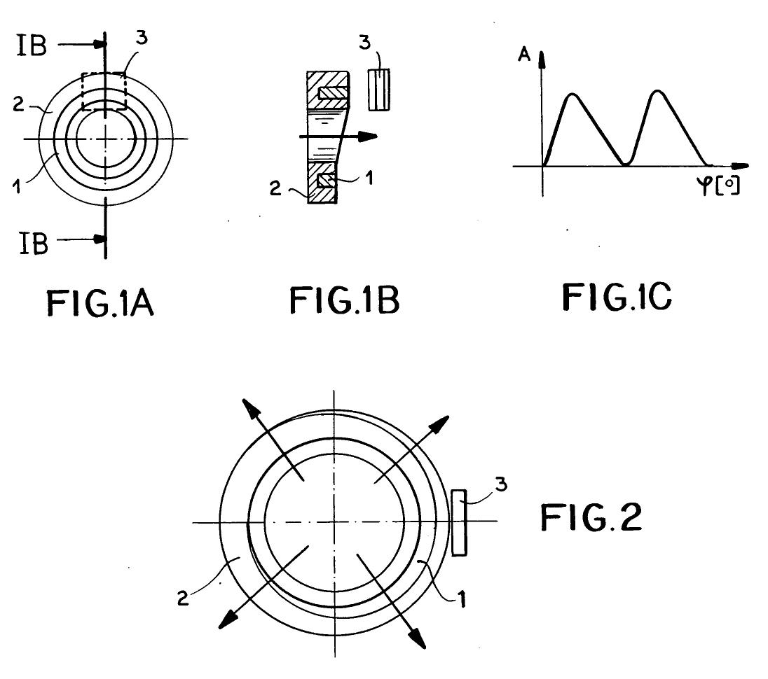

FIG. 1 is a sensor system comprising a magnet with a continuously angularly varying cross-section, the magneto-sensitive sensor confronting the face of the magnet extending perpendicular to the axis of rotation of the magnet,

FIG. 2 is a sensor system comprising a magnet with a continuously angularly varying cross-section, the magneto-sensitive sensor being juxtaposed with the side of the magnet extending parallel to the axis of rotation of the magnet.

FIG. 1 shows in detail a sensor system that is configured to detect angular movements of measurement objects (not shown in detail). A circular magnet 1 is provided that is embedded in a support 2 (see illustration at the center of FIG. 1, section A-A from the left illustration of FIG. 1). In this center illustration, it is apparent that the magnet 1 (cross-hatched) is embedded in the magnet support 2 (hatched). The end face perpendicular to the axis of rotation of the sensor (formed by elements 1 and 2) is not imbedded in the magnet support 2, but could be. This face of the magnet 1 is juxtaposed with a magneto-sensitive sensor 3, for example a Hall-effect sensor. Upon rotation of the measurement object, this angular movement is captured by the magneto-sensitive sensor 3 that emits an output signal that is shown by way of example in the right illustration according to FIG. 1. The X-axis shows the angle of rotation 4 in degrees and the Y-axis shows the amplitude of the output signal A of the magneto-sensitive sensor 3. In this embodiment, the magneto-sensitive sensor 3 is juxtaposed with the face of the magnet extending perpendicular to the axis of rotation of the magnet 1.

Furthermore the magneto-sensitive sensor 3 can also be mounted laterally of the magnet 1, as is shown. The helical shape is then formed accordingly toward the outside and the magnetization is selected accordingly.

The sensor system can output analog output voltage signals. In addition, it is conceivable to provide an interface for the sensor system, which interface emits voltage- or current-related pulse width-modulated signals.

### REFERENCE LIST

1 magnet
2 magnetic-field sensor
4 magnet support

1. A sensor system for measuring angular movements of measurement objects with at least one magnet and a magneto-sensitive sensor wherein the magnet is imbedded in a magnet support and is circularly arcuate, and the magnet has a cross section that varies angularly.

2. The sensor system according to claim 1 wherein the cross section varies angularly in a uniform linear manner.

3. The sensor system according to claim 1 wherein the cross section varies angularly in nonlinear constant manner.

4. The sensor system according to claim 1 wherein the magneto-sensitive sensor is juxtaposed with a surface of the magnet extending parallel to the rotation axis of the magnet.

5. The sensor system according to claim 1 wherein the magneto-sensitive sensor is juxtaposed with a surface of the magnet extending perpendicular to the rotation axis of the magnet.

6. The sensor system according to claim 1 wherein the magnet support is made of an injection-molded plastic.

7. The sensor system according to claim 1 wherein the magnet support is a separate part or part of the object being measured.

8. A sensor system comprising:
a support rotatable about an axis;
an arcuate magnet mounted on the support generally centered on the axis and having a cross-sectional shape with a dimension varying angularly regularly; and
a magneto-sensitive sensor fixed adjacent the support and oriented to respond to a magnetic field of the magnetic.

9. The sensor system defined in claim 1 wherein the sensor is a Hall-effect sensor.

10. The sensor system defined in claim 1 wherein the magnetic is of varying thickness measured radially.

11. The sensor system defined in claim 10 wherein the sensor is juxtaposed with a radially outwardly directed surface of the magnet.

12. The sensor system defined in claim 10 wherein the magnet has a radially outwardly directed outer face and a radially inwardly directed inner face, one of the faces being formed substantially as a cylinder centered on the axis and the other of the faces being formed substantially as a spiral centered on the axis.

13. The sensor system defined in claim 12 wherein the outer face is formed as a spiral.

14. The sensor system defined in claim 1 wherein the magnet is of varying thickness measured axially.

15. The sensor system defined in claim 14 wherein the sensor is juxtaposed with an axially directed end face of the magnet.

16. The sensor system defined in claim 1 wherein the support is nonmagnetic and the magnet is imbedded in the support.

17. The sensor system defined in claim 16 wherein the support is plastic.
